(19) United States
(12) Patent Application Publication
(10) Pub. No.: US 2012/0040144 A1
(43) Pub. Date: Feb. 16, 2012

(54) Corrugating Adhesive and Use Thereof

(76) Inventors: Shawn DeJong, Apple Valley, CA (US); Mark Mitchell, Mansfield, TX (US)

(21) Appl. No.: 13/190,825

(22) Filed: Jul. 26, 2011

Related U.S. Application Data
(60) Provisional application No. 61/372,537, filed on Aug. 11, 2010.

(51) Int. Cl. B32B 3/28; C08L 1/00

(52) U.S. Cl. 428/182; 524/35

(57) ABSTRACT

A colloid protected polyvinyl acetate emulsion resin can be employed as a corrugating adhesive. The use of this adhesive is useful for increasing the line speed for the manufacture of double and triple wall paperboard constructions.

### CROSS-REFERENCE TO RELATED APPLICATION

This application claims the benefit of U.S. Provisional Patent Application No. 61/372,537 filed Aug. 11, 2010, the contents of which are incorporated herein by reference.

### FIELD OF THE INVENTION

The present invention relates to a corrugating adhesive used in the manufacture of corrugated boards.

### BACKGROUND OF THE INVENTION

Corrugated paper board is commonly prepared by first forming a corrugated element or core by passing a cellulosic sheet between corrugating rolls forming a substantially sinusoidal or serpentine cross-section in the sheet. An adhesive is commonly applied to the tips of the thus formed sinusoidal portion called flutes and a noncorrugated or planar cellulosic liner is applied against the adhesive coated flutes of the corrugated elements as the corrugated sheet passes between a corrugating roll and a pressure roll. The resulting paper product having the corrugating medium on one side and the liner on another side is called a single-faced web. The single-faced element may be used as is in certain applications as a liner or buffer material within a container. More commonly adhesive is applied to the flute tips of the single-faced web and a second liner is subsequently applied to the adhesive liner in a “double facer” operation. The second liner is exposed to conditions of heat and pressure during its contact with the adhesive. In practice, the liner of corrugated paperboard most frequently encountered has two plane sides placed on each side of the corrugated medium. Depending on the specific strength desired, a sheet of corrugated paperboard may also be provided with a more complex structure, such as two outer ones liners and one inner liner separating the two corrugated medium (referred to as double wall board) and three corrugated mediums and four liners (referred to as triple wall board).

Starch-based adhesives are most commonly used in the corrugating process due to their desirable adhesive properties, low cost and ease of preparation. The most fundamental corrugating adhesive, commonly referred to as a “Stein-Hall” formulation, is produced by gelatinizing starch in water with sodium hydroxide (caustic soda) to yield a primary mix of gelatinized or cooked carrier, which is then slowly added to a secondary mix of raw (ungelatinized) starch, borax and water. In conventional corrugating processes, the adhesive is applied to the tips of the fluted paper medium or single-faced board, whereupon the application of heat and pressure causes the raw starch to gelatinize, resulting in an instantaneous increase in viscosity and formation of the adhesive bond. The adhesive is applied while relatively cool and then requires the application of high temperatures (usually at between 60° and 66° C.) at the points of bonding to effect in situ gelatinization of the raw starch granules. One drawback is that the corrugating process depends on heat transfer through several layers of constructions to effect gelation, and hence the line speed is significantly reduced (e.g., from about 1,000 fpm to about 300 fpm). As the thickness and layers of the construction increases, the line speed further decreases.

There is a need in the art for corrugating adhesives and methods to increase the line speed of the corrugating process. The current invention fulfills this need.

### BRIEF SUMMARY OF THE INVENTION

The invention provides a resin emulsion corrugating adhesive. High temperature is not required for this adhesive to set the bond.

In one embodiment, the corrugating adhesive is a polyvinyl acetate emulsion resin with at least one protective cellulose colloid. Suitable protective cellulose colloids for the polyvinyl acetate are methylcellulose, ethylcellulose, hydroxyethyl cellulose, hydroxypropyl cellulose, hydroxyethyl methyl cellulose, hydroxypropyl methyl cellulose, carboxymethyl cellulose. In another embodiment, the corrugating adhesive is a polyvinyl acetate emulsion resin with hydroxyethyl cellulose protective colloid.

Another embodiment is directed to a method of bonding a first substrate to a second substrate. The substrates may be the same or different. In one embodiment, both the first and the second substrates are cellulosic substrates. In a further embodiment, the cellulosic substrates are mediums and planar liner boards.

The invention further provides the art with a process for manufacturing a paperboard product. The process of the invention comprises applying a layer of the adhesive of the invention to a first and/or second substrate, which first and second substrates are independently selected from the group consisting of corrugated mediums and liner boards. The first substrate and the second substrate are brought together such that said adhesive layer is located between the first substrate and the second substrate, and whereby the first substrate becomes bonded to the second substrate. In one embodiment, the paperboard product prepared using the adhesive of the invention is a corrugated board comprising at least one corrugated medium and at least one liner board. In a further embodiment, the corrugated medium is bonded to at least one liner board using the adhesive of the invention. Adhesives prepared by these processes are encompassed by the invention, as are articles made with the prepared adhesives.

### DETAILED DESCRIPTION OF THE INVENTION

The invention provides the art with a novel corrugating adhesive that can be employed to increase the line speed, especially in the manufacture of double and triple wall board constructions. The corrugating adhesive comprises a polyvinyl acetate emulsion resin with at least one cellulose protective colloid.

Resin emulsions which may be used in the practice of the invention are emulsions and mixtures having a glass transition temperature greater than about 10° C. Polyvinyl acetate is preferred for use in the practice of the invention. Mixtures of two or more polyvinyl acetates and mixtures of polyvinyl acetate and other polymer emulsions and monomers, including but not limited to ethylene vinyl acetate and ethylene and/or acrylic monomers, are encompassed. Polyvinyl acetate may be prepared using a continuous or a batch process. Polyvinyl acetates emulsion mixtures wherein the polyvinyl acetates used are prepared by one method or by both methods may be used.

The resin emulsion is in the amount of at least 80 wt % and up to 100 wt % of the total adhesive. The total adhesive includes the weight of the water. The solids content of the resin emulsion is at least 40% of the resin emulsion.

Protective colloids or emulsifying agents are added with the polyvinyl acetate to protect polyvinyl acetate from coalescence and subsequent separation. Useful protective colloids include anionic, cationic, amphoteric, or nonionic surfactants. Preferred protective colloids are nonionic surfactants and include starch, dextrin, cellulose, gum or combinations thereof. One preferred protective colloid for polyvinyl acetate is cellulose. Preferred cellulose include methylcellulose, ethylcellulose, hydroxyethyl cellulose, hydroxypropyl cellulose, hydroxyethyl methyl cellulose, hydroxypropyl methyl cellulose, carboxymethyl cellulose and the like. Particularly preferred cellulose is hydroxyethyl cellulose.

Protective colloids are present in the amount of about 0.1 to 25 wt %, and about 0.1 to about 10 wt %, and more preferably from about 0.1 to about 5 wt %, and more preferably from about 0.1 to about 3 wt % based on the total weight of the resin emulsion.

In addition to the polyvinyl acetate emulsion resin, other components typical of adhesive compositions may be added. Such additives include, but are not limited to, plasticizers, acids, waxes, resins, tackifiers, foamers, defoamers, preservatives, bases, fillers, dyes, pigments, UV indicators, crosslinkers, rheology modifiers and other additives commonly used in the adhesive art. When used, the additives will typically be added in amounts up to about 20% by weight, based on the adhesive composition as a whole. More preferably that additives may be added, from about 0.05 to about 20% by weight, and preferably at from about 0.2 to about 10% by weight.

The adhesive composition of the invention may also be foamed by the addition of energy, by means known in the art such as, but not limited to, by mechanical and/or chemical means. Air or other gases are added to the adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means. The amount of air dispersed in the adhesive can vary depending on the particular formulation, but will generally be from about 10% (by volume) up to about 50% (by volume) or greater.

The method of the invention comprises applying to the tips of flutes of a corrugated medium a layer of adhesive, applying a liner to the adhesive coated tips of the corrugated paper and allowing the adhesive to dry. Alternatively, the adhesive may be applied/coated onto the surface of a liner board, the liner is applied to the corrugated flute tips, and the adhesive is allowed to dry. The adhesive may be applied to specific sections of the liner, or to the entire surface area of the liner.

The procedures employed in the production of corrugated paperboard in a double-backer typically involve a continuous process wherein a strip of paperboard is first corrugated by means of heated, fluted rolls. The protruding tips on one side of this fluted paperboard strip are then coated with an adhesive, and a liner (also known as a facing), is thereafter applied to these tips. Stein-Hall adhesive is typically used to form these single-face boards. By applying heat, typically about 140 to about 150° F., and pressure, typically at around 300 psi via roller or by hot pressing, to the two paperboard strips thus brought together, an adhesive bond is formed therebetween.

To form multiple wall boards, inner fluted layer is sandwiched between two facings, a second operation is performed wherein a second adhesive is applied to the exposed tips of the single-faced board and the adhesive-coated tips are then pressed against a second facing in the combining section of the corrugator under the influence of pressure and heat, forming a double wall board. While the second adhesive may also be a Stein-Hall adhesive, as the thickness of the paperboard increases by additional faces and additional mediums, the speed of the double-backer machinery must be slowed to ensure good bond formation of the Stein-Hall adhesive. The Stein-Hall adhesive must reach temperatures of at least 140-150° F. for the slurry starch to gel and set the bond. As the overall thickness of the paperboard increases, the ability of heat to transport through the various paperboard layers to achieve the necessary gel temperature becomes more difficult. This problem becomes even more exaggerated for triple wall boards because heat must travel five layers of paperboards and three layers of air. Hence, the speed of the double-backer must be set slower, typically about 300-350 fpm, to ensure that the Stein-Hall adhesive reaches the gelation temperature.

Thus, it is advantageous to employ a different adhesive in the second applicator that does not require high heat to set the bond. The cellulose protected polyvinyl acetate as the second adhesive in the above process is advantageous because high temperature gelation is no longer necessary. The cellulose protected polyvinyl acetate adhesive can increase the line speed by 25%, in some embodiment 40%, in some embodiment 50%. However, it is important that the second adhesive is not negatively affected or contaminated by the borated and caustic starched Stein-Hall adhesive. Unlike other resin emulsions, the cellulose protected polyvinyl acetate adhesive can be used as the second adhesive in the corrugating process without the fear of potential contamination of caustic and/or borax reagents.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

I/We claim:

1. A corrugating adhesive comprising a polyvinyl acetate emulsion resin with a protective cellulose colloid.

2. The corrugating adhesive of claim 1 wherein the protective cellulose colloid is selected form the group consisting of methylcellulose, ethylcellulose, hydroxyethyl cellulose, hydroxypropyl cellulose, hydroxyethyl methyl cellulose, hydroxypropyl methyl cellulose, carboxymethyl cellulose and mixtures thereof.

3. The corrugating adhesive of claim 2 wherein the protective cellulose colloid is hydroxyethyl cellulose.

4. The corrugating adhesive of claim 3 comprising a blend of at least two polyvinyl acetates.

5. The corrugating adhesive of claim 3 comprising a polyvinyl acetate copolymerized with acrylic and/or ethylene polymer.

6. The corrugating adhesive of claim 3 further comprising an additive.

7. The corrugating adhesive of claim 6 wherein the additive is selected form the group consisting of plasticizer, acid, wax, synthetic resin, tackifier, defoamer, preservative, base, dye, pigment, UV indicator, surface-active agent and mixtures thereof.

8. An article of manufacture comprising the corrugating adhesive of claim 1.

9. The article of claim 8 which comprises at least one corrugating medium and at least one liner, wherein the corrugating medium is bonded to the liner using said corrugating adhesive.

10. The article of claim 9 which is a double wall corrugated board.

11. The article of claim 9 which is a triple wall corrugated board.

12. A method for bonding materials together which comprises applying the corrugating adhesive composition of claim 1 to a first substrate, bringing a second substrate in contact with the adhesive composition applied to the first substrate, and subjecting the applied composition to conditions which will allow the composition to cool and form a set bond, wherein one of said first or second substrate is a wood composite and the other of said first or second substrate is a high pressure laminate.

13. The method of claim 12 wherein the adhesive has a solids content of greater than about 40%, based on the total weight of the adhesive.
